(19) United States
(12) Patent Application Publication
(10) Pub. No.: US 2006/0283989 A1
(43) Pub. Date: Dec. 21, 2006

(54) Method and device for applying wall coatings

(75) Inventor: David B. Lytle, Cabot, PA (US)

Correspondence Address: THE WEBB LAW FIRM, P.C., 700 KOPPERS BUILDING, 436 SEVENTH AVENUE, PITTSBURGH, PA, 15219, US

(73) Assignee: David B. Lytle Products, Inc., Cabot, PA (US)

(21) Appl. No.: 11/156,387

(22) Filed: Jun. 20, 2005

(51) Int. Cl. B05B 5/025; F23D 11/32; B05B 5/00

(52) U.S. Cl. 239/690; 239/3; 239/690.1

(57) ABSTRACT

A method of applying a magnetic coating to a surface including steps of releasably attaching a framing member to a surface, the framing member defining at least one opening; applying a magnetic coating to the surface within said opening; allowing the magnetic coating to dry; and removing the framing member from the surface, such that the magnetic coating remains fixed to the surface. The framing member is removed from the surface, and additional magnetic coating is applied to the surface to fill in gaps left from removing the framing member.

### BACKGROUND OF THE INVENTION

1. Field of the Invention

The present invention relates to a method of making a magnetically attractive coating composition, more particularly, to a system for producing magnetically attractive surfaces.

2. Description of Related Art

Typical magnetically attractive surfaces found in homes and businesses include refrigerators, filing cabinets and other appliances or furnishings manufactured from iron alloys. Small magnets with various indicia, decorative patterns, or other items attached to the magnets are placed against the surface for viewing as movable, temporary displays. While use of magnets in displays in other locations in a home or business may be desirable, magnetically attractive surfaces (those containing an iron alloy) are generally not present throughout such buildings. To overcome this barrier, a sheet of magnetically attractive material, often mounted in a frame and referred to as a magnet board, may be attached to a wall or other surface. Magnetic objects can then be mounted magnetically to the magnetic sheet. Nevertheless, this route to obtaining a magnetic surface (mounting a magnet board) is limited in its use.

One alternative to mounting a magnet board to a surface is to paint a surface with a magnetically attractive coating composition. One such coating composition is described in U.S. Pat. No. 3,503,882 to Fitch. The composition described therein includes iron powder (in an amount of 75-85 wt. %) and resin along with additives of polyethylene wax, and an alkyl ammonium bentonite with optional colorants all dispersed in the solvent. The additives (polyethylene wax and alkyl ammonium bentonite) are included in order to stabilize the composition and prevent slumping of the composition when applied to a surface. Another similar composition is disclosed in U.S. Pat. No. 5,587,102 to Stern. The composition described therein includes iron, water, thickener, rust inhibitor, drying agent, surfactant, antimicrobial/antifungal agent, defoamer and ammonia. This long list of ingredients is considered necessary to provide a magnetically attractive composition having an extended shelf life and which is sufficiently viscous for applying to a substrate.

The need for various additives in a magnetically attractive coating composition is also described in U.S. Pat. Nos. 5,609,788 and 5,843,329, both to Deetz. The composition described therein includes ferromagnetic powder and a surfactant with other optional additives for mixing into a paint. Again, a surfactant is considered required in order to form a stable dispersion of the magnetically attractive powder within the paint.

While coating these compositions allows production of magnetically attractive surfaces, their costs are relatively high compared to conventional coatings (architectural paint) and magnet boards. Accordingly, a need remains for an inexpensive magnetically attractive coating composition which is simple to prepare and includes a minimum number of components.

### SUMMARY OF THE INVENTION

This need is met by the method of the present invention that includes applying a magnetic coating to a surface comprising the steps of releasably attaching a framing member to a surface, the framing member defining at least one opening, applying a magnetic coating to the surface within the opening, allowing the magnetic coating to dry, and removing the framing member from the surface, such that the magnetic coating remains fixed to the surface. Removal of the framing member yields at least one gap in the coating that may be filled with an additional application of magnetic coating to the surface in an amount to fill the gap. When the framing member includes a plurality of elongated members, the magnetic coating may be filled into the openings between the elongated members using a tool spanning the opening. The thickness of the magnetic coating generally is substantially the same as the thickness of the framing member, such as up to 0.25 inch thick or 1/16 to ⅛ inch thick.

The magnetic coating is a paste that can be applied to the framing member or directly to a surface such as a wall in a single coating and can support a magnetically attractive display device. In one embodiment, the magnetic coating is paste consisting of 70-90 wt. % iron particles and 10-30 wt. % paint. The paint may be a decorative paint or a primer paint.

It has been found that when iron particles are added to paint at a concentration of 70-90 wt. %, the resultant paste-like viscosity of the composition is sufficient to maintain the particles dispersed within the mixture for a sufficient time to permit coating a surface therewith. No other components are needed to create the paste-like magnetic coating composition. When the mixture is applied to a surface, particularly a vertical surface, it forms uniform coating without slumping. The iron particles may be sized up to about 100 mesh (149 microns) with a portion thereof being finer than 325 mesh (less than 44 microns). The paint may be an oil-based paint or latex paint. The present invention is particularly suited for use with a primer paint. The magnetically attractive coating composition is prepared and applied to a surface and dried. The dried, magnetically attractive surface may then be coated with a decorative coating, such as a colored paint. The strength of the magnetic attraction between the magnetically attractive coating composition applied to a surface and a magnet may be increased by applying multiple coats of the magnetically attractive coated composition to a surface.

### BRIEF DESCRIPTION OF THE DRAWINGS

FIG. 1 is a plan view of a method of applying a magnetically attractive coating composition of the present invention between portions of a framing member;

FIG. 2 is a perspective view of the method shown in FIG. 1; and

FIG. 3 shows an optional step of applying additional magnetically attractive coating after removal of the framing member.

### DETAILED DESCRIPTION OF THE INVENTION

The present invention includes methods of making and using a magnetically attractive coating composition. A unique feature of the present invention is the use of a minimum number of components. In one embodiment of the invention, a conventional coating composition (such as a commercially available paint product) is mixed with iron particles and no other components. The iron particles are mixed into the paint to produce a mixture having about 70 to about 90 wt. % iron particles. The iron particles are sized up to about 100 mesh (149 microns) with a portion thereof being finer, such as about 25% being 325 mesh (less than 44 microns). The conventional paint may be an oil-based paint or a latex paint. A particularly suitable paint is a primer paint, such as is used on a wall as a primer before applying a decorative paint.

In one embodiment, a magnetically attractive coating composition is prepared by mixing 7 to 9 pounds, or about 8 pounds, of iron particles into a gallon of conventional paint. The mixture is stirred until the iron particles are distributed uniformly. The mixture may be applied to a surface by conventional painting techniques. For large areas, such as a 20 square foot area, application with a paint roller is suitable. Acceptable rollers include a ¼ to ½ inch foam roller or a low nap fiber roller. The coating is allowed to dry, and a second coating or multiple additional coatings may be applied to increase the magnetic attractiveness of the final coating composition on the surface. For stronger magnetic attraction, 3 or 4 or more coats may be applied to the surface. In each case, the coating composition is preferably dried completely before an additional coating is applied thereto.

The iron particles generally impart a grayish color to the magnetically attractive coating composition. Primer paint typically has a dull white color; hence, addition of the iron particles thereto does not substantially change the color. Hence, the present invention is particularly suited for use with primer paint which is designed to be covered by a decorative paint or other decorative coatings or coverings, such as wallpaper or fabric. It will be appreciated that thicker decorative coatings or coverings may require multiple layers of the magnetically attractive coating composition thereunder to ensure sufficient magnetic attractiveness. The iron particles are subject to oxidation (rust). The decorative coating or other finish coatings may also be beneficial as a moisture barrier to the iron particles present in the magnetically attractive coating. Due to the iron particles, the magnetically attractive coating has some texture (roughness) when applied to a surface. By covering the magnetically attractive coating with a decorative paint or the like, the roughness of the magnetically attractive coating is smoothed out. The end result is a lightly textured surface that magnetically attracts magnets thereto.

In another embodiment of the invention, the magnetically attractive coating composition of the present invention is applied to a substrate, such as a wall, as a thick paste or coating composition with the consistency of putty. For a thick paste, about 15 to 20 pounds of iron particles are mixed with one gallon of conventional paint. Lower amounts of iron particles may also be used, e.g., about 8 to less than 15 pounds per gallon of paint. The paste-like composition may be applied in a single coating to a surface such as a wall. Upon drying, the composition is suited for magnetically attracting display devices (magnetically backed picture frames and the like) thereto.

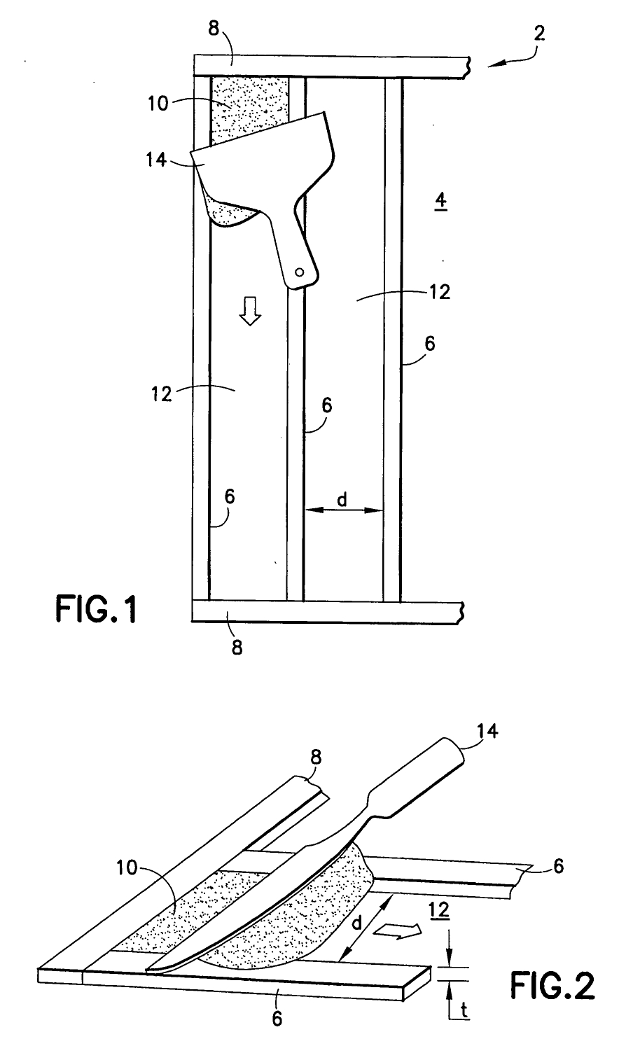

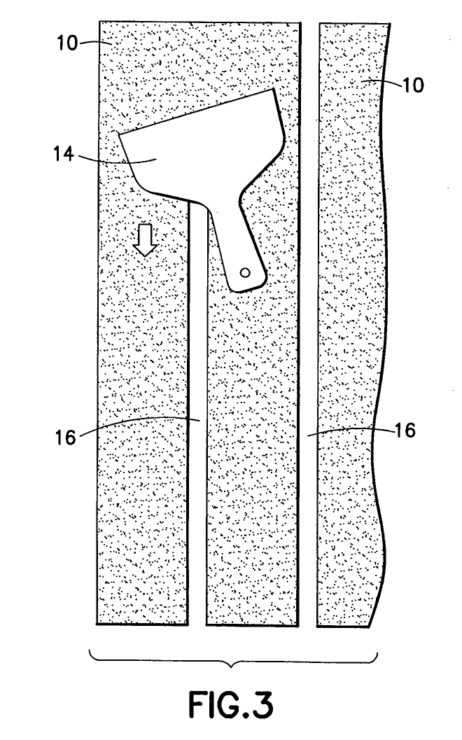

Referring to FIGS. 1-3, a framing member 2 is attached to a surface such as a wall 4. The framing member may include a plurality of elongated members 6 applied to the wall at spaced apart intervals and end portions 8. The framing member may be produced from wood, plastic, metal or other material and may be reusable. The framing member may be releasably attached to the wall using adhesives or fasteners. The magnetically attractive coating composition 10 is applied into openings 12 formed between the elongated members 6 and end portions 8 such as by using a tool 14 such as a trowel or a putty knife. In one embodiment of the invention, the distance (d) between the elongated members 6 is determined by the width of the application surface of the tool 14. By employing a tool 14 having a longer dimension than the distance (d) between the elongated members 6, the tool 14 can be dragged along the elongated member 6 to form an even and contiguous coating between the elongated members 6. The thickness of the coating composition 10 may be determined by the thickness (t) of the elongated members 6 as shown in FIG. 2. For example, if the elongated members 6 are 1/16 inch or ⅛ inch thick, and the tool 14 is used to drag the coating composition 10 between the elongated members 6, the resulting coating composition 10 has essentially the same thickness ( 1/16 or ⅛ inch) as the elongated members 6. In this manner, the thickness of the coating composition 10 can be adjusted by employing various thicknesses of the elongated members 6.

The coating composition 10 is allowed to dry. After drying, the framing member 2 is removed as shown in FIG. 3 yielding gaps 16 in the coating composition 10. Additional coating composition 10 can be used to fill in these gaps 16 if desired, as shown in FIG. 3. The present invention also includes a magnetic coating produced according to the above-described method.

In another embodiment, the paste-like coating composition containing only a paint composition and iron particles is applied directly to a surface such as a wall. The paste-like coating composition may be applied in a single coating. A trowel may be used to apply the coating composition. The coating composition may be 1/16 to ⅛ inch thick.

Unless otherwise indicated, all numbers expressing quantities of ingredients and the like used in the specification and claims are to be understood as being modified in all instances by the term “about”. It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

The invention claimed is:

1. A method of applying a magnetic coating to a surface comprising the steps of:
releasably attaching a framing member to a surface, the framing member defining at least one opening;
applying a magnetic coating to the surface within said opening;
allowing the magnetic coating to dry; and
removing the framing member from the surface, such that the magnetic coating remains fixed to the surface.

2. The method of claim 1, wherein said removing of the framing member yields at least one gap in the coating, the method further comprises a step of applying additional magnetic coating to the surface in an amount to fill the gap produced upon removing the framing member.

3. The method of claim 1, wherein the framing member comprises a plurality of elongated members and said applying step comprises filling the magnetic coating into the openings between the elongated members using a tool spanning the opening.

4. The method of claim 1, wherein the thickness of the magnetic coating is substantially the same as the thickness of the framing member.

5. The method of claim 4, wherein the magnetic coating is up to 0.25 inch thick.

6. The method of claim 1, wherein the magnetic coating consists of 70-90 wt. % iron particles and 10-30 wt. % paint.

7. The method of claim 1, wherein the magnetic coating is applied in a single coating.

8. The method of claim 7, wherein the magnetic coating is configured to support a magnetically attractive display device.

9. A magnetic coating produced according to the method of claim 1.

10. The magnetic coating of claim 9, wherein the coating is applied to a wall.

11. A method of making a surface magnetic attractive comprising the steps of:
providing a paste consisting of iron particles and a paint composition, the iron particles being present in the paste in an amount of 70-90 wt. %; and
applying the paste to a surface in a single coating.

12. The method of claim 11 wherein the paste is applied by trowelling the paste onto the surface.

13. The method of claim 12 wherein the surface is a wall.

14. The method of claim 11 wherein the paint composition is selected from the group consisting of a decorative paint and a primer paint.

15. The method of claim 11 wherein the coating is 1/16 to ⅛ inch thick.

16. A magnetically attractive paste consisting of iron particles and a paint composition, the iron particles being present in the paste in an amount of 70-90 wt. %, wherein said paste has a consistency such that said paste is applicable to a surface in a single coating that magnetically attracts display devices thereto.

17. The magnetically attractive paste of claim 16 wherein the surface is a wall.

18. The magnetically attractive paste of claim 16 wherein the paint composition is selected from the group consisting of a decorative paint and a primer paint.

19. The magnetically attractive pastes of claim 16 wherein the coating is 1/16 to ⅛ inch thick.
